(19) United States
(12) Patent Application Publication
(10) Pub. No.: US 2022/0198397 A1
(43) Pub. Date: Jun. 23, 2022

(54) VIRTUAL INTERVIEW SYSTEM

(71) Applicants: Adam Lavoignet, Irvine, CA (US); Edwin Christopher, Irvine, CA (US); Hector Haget, Trabuco Canyon, CA (US); Hong Le, Redondo Beach, CA (US)

(72) Inventors: Adam Lavoignet, Irvine, CA (US); Edwin Christopher, Irvine, CA (US); Hector Haget, Trabuco Canyon, CA (US); Hong Le, Redondo Beach, CA (US)

(21) Appl. No.: 17/127,894

(22) Filed: Dec. 18, 2020

(51) Int. Cl. G06Q 10/10; H04N 7/14; H04L 12/58; G06F 40/174

(52) U.S. Cl. CPC G06Q 10/1053; G06F 40/174; H04L 51/046; H04N 7/144

(57) ABSTRACT

A virtual interview system including at least one job candidate device and at least one organization device in operable communication with a network. An application system is in operable communication with the network to transmit a plurality of questions to a user interface of the job candidate device. An artificial intelligence engine analyzes each response to the plurality of questions and assigns a point value based on the response, wherein each point value for each of the plurality of questions is totaled to determine if a threshold value is reached. The threshold value determines if the job candidate is permitted to schedule a virtual interview.

### TECHNICAL FIELD

The embodiments generally relate to computerized systems for user networking and, more specifically, relate to computerized systems to permit users to network with one another based on their location.

### BACKGROUND

Historically, most organizations conduct on-site and in-person job interviews with job candidates when contemplating hiring employees. Interviews are conducted as an essential component of evaluating the job candidates for filling a particular position; however, in-person interviews can be costly for the organization if travel expenses are required, and employees must take time to conduct the on-site interview. Rescheduling can be difficult or impossible where interviewees must commit to an entire day for traveling to and undergoing the interview process. This is compounded as organizations will often interview numerous job candidates in a short period of time over multiple interview rounds.

Prior to scheduling the interview, candidates may be prescreened to ensure they meet certain requirements established by the organization for particular job opening. For example, candidates may be prescreened based on education history (e.g., do they have a certain degree) or by qualifications (e.g., are they licensed to perform a certain task or to work in a particular industry). Prescreening can take a large amount of time due to the effort required to obtain and difficulties in normalizing the information received from applicants and further narrowing down the potential applicants to only those the organization is interested in pursuing further.

In recent years, many organizations have increased their remote workforce while some have eliminated in-office work entirely. In such, interviews are now frequently conducted over telecommunications systems or phone conference systems not specifically designed for prescreening the candidate and conducting various stages of the interviewing process.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a virtual interview system including at least one job candidate device and at least one organization device in operable communication with a network. An application system is in operable communication with the network to transmit a plurality of questions to a user interface of the job candidate device. An artificial intelligence engine analyzes each response to the plurality of questions and assigns a point value based on the response, wherein each point value for each of the plurality of questions is totaled to determine if a threshold value is reached. The threshold value determines if the job candidate is permitted to schedule a virtual interview.

The virtual interview system can be utilized by organizations to prescreen job candidates prior to scheduling an interview between the organization and the job candidate. The system greatly reduces the time spent prescreening applicants by autonomously determining if the job candidates meet prerequisites input by the organization using an artificial intelligence engine. Once job candidates have been accepted through the prescreening process, the job candidates and/or the organization can schedule and conduct virtual interviews.

In one aspect, the user interface is in operable communication with a job candidate database and an organization database.

In one aspect, the job candidate database stores job candidate information, wherein the job candidate information is transmitted to the organization device.

In one aspect, the organization database stores organization information comprising job openings and the plurality of questions.

In one aspect, a communications module transmits text messages from the organization to the job candidate.

In one aspect, a notifications engine transmits notifications to the job candidate.

In one aspect, a scheduling module schedules the virtual interview if the job candidate meets the threshold value.

In one aspect, the job candidate selects a date and a time to schedule the virtual interview.

In one aspect, a URL generator generates a unique URL and transmits the unique URL to the job candidate at a time of the virtual interview.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system, according to some embodiments;

FIG. 3 illustrates a block diagram of the prescreening system, according to some embodiments;

FIG. 4 illustrates a flowchart of the prescreening process wherein questions are transmitted by the artificial intelligence system on behalf of an organization to a job candidate, according to some embodiments;

FIG. 5 illustrates a screenshot of the applicant interface wherein a member of the organization can review applicant information and responses to the questions, according to some embodiments;

FIG. 6 illustrates a screenshot of the question interface wherein the member of the organization can interact with questions to be transmitted to job candidates, according to some embodiments;

FIG. 7 illustrates a screenshot of the interview interface wherein the job candidate and organization conduct a virtual interview, according to some embodiments;

FIG. 8 illustrates a flowchart of the user flow implemented by the virtual interview system, according to some embodiments; and

FIG. 9 illustrates a block diagram of the server engine and modules, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a virtual interview system which can be utilized by organizations to prescreen job candidates prior to scheduling an interview between the organization and the job candidate. The system greatly reduces the time spent prescreening applicants by autonomously determining if the job candidate meets prerequisites input by the organization using an artificial intelligence engine. Once job candidates have been accepted by the prescreening process, the job candidates and/or the organization can schedule and conduct virtual interviews.

As used herein, the term “organization” may be used to describe a user utilizing the embodiments to prescreen job candidates, schedule, and conduct interviews. In such, the organization may be a company or individual looking to hire job candidates.

As used herein, the term “job candidate” relates to a user utilizing the system to seek a job position, submit a resume or similar information, and schedule and conduct an interview with the organization.

The job opening may be an opening for a permanent hire, temporary hire, full- or part-time employment opportunity. Similarly, the job opening may be for a contract or other agreement between the organization and the job candidate.

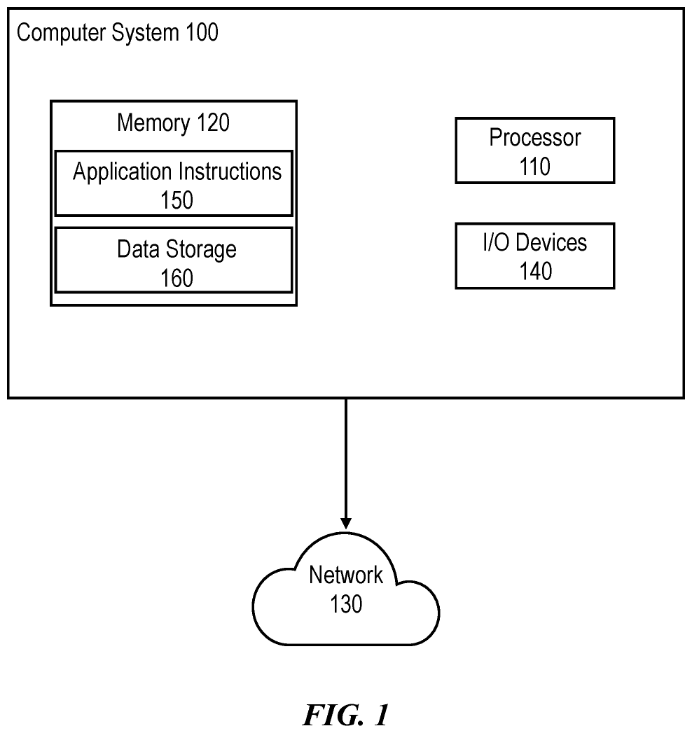

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

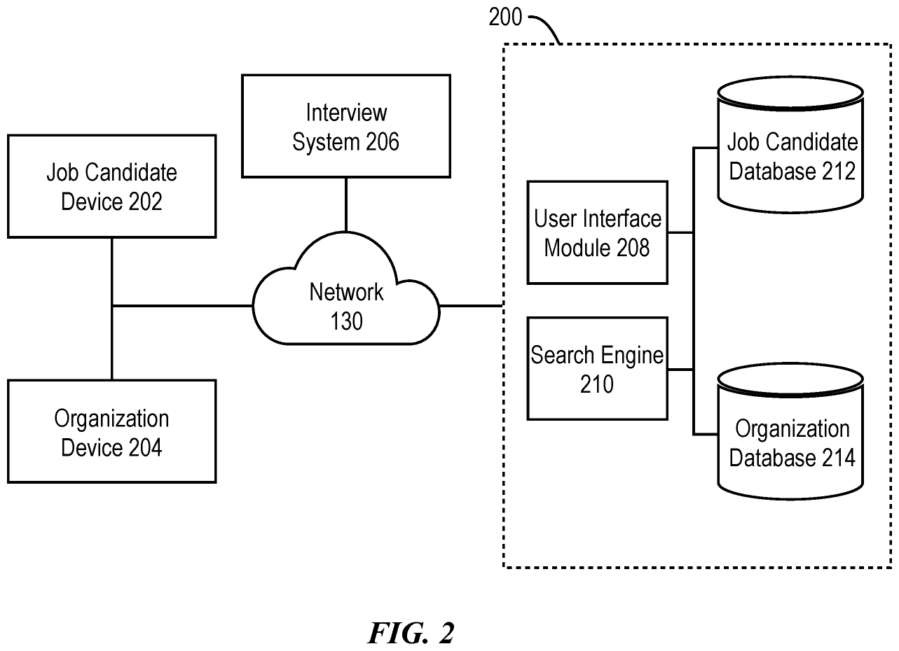

FIG. 2 illustrates a block diagram of the application system 200 utilized by the system to prescreen job candidates and schedule virtual interviews between the job candidate and organization. The job candidate utilizes a job candidate device 202 (e.g., a computer, smartphone, tablet, etc.) to operate the functionalities of the application system 200 via network 130 such as to submit a resume, communicate with the organizations, and perform an interview. The organization utilizes an organization device 204 (e.g., a computer, smartphone, tablet, etc.) to operate the functionalities of the application system 200 including prescreening and reviewing information submitted by the job candidates, communicating with job candidates, and conducting interviews between the organization and the job candidates. An interview system 206 is provided to allow for video and/or audio communications between the job candidate and organization. The interview system 206 may provide an interview interface, which can be utilized during the interview process to display job candidate information, organization information, display imagery, perform virtual tours of the organization, and to transmit audio and video communications in real-time between the job candidate and organization. The interview system 206 may also function to capture audio and/or video submitted by the job candidate to permit recorded interviews. For example the organization may provide pre-recorded interview questions, which are transmitted to the job candidate. The job candidate may then submit responses in an audio and/or video format to be returned to the organization.

In further reference to FIG. 2, the application system 200 may include a user interface module 208 to display information stored in the job candidate database 212 and organization database 214. The application engine 200 may also transmit text messages to and from the job candidate device during the prescreening process. A search engine 210 permits the job candidate and/or organization to search the job candidate database 212 and organization database 214. The job candidate database 212 may store job candidate information including resumes and similar information associated with the job candidate, job candidate preferences and interests (e.g., preferred job opportunities), and the like. The organization database 214 may store organization information including job opportunities available, pre-requisites for the job opportunities, organization details, etc.

The job candidate device 202 may be utilized by the job candidate to input job candidate information to the system. For example, the job candidate device 202 may be utilized to submit a resume, answer a series of questions submitted by the organization, and transmit audio and video information during an interview or during the prescreening process.

The organization device 204 may be utilized by a member of the organization or group thereof to submit job opportunities to the system, receive job candidate information, submit questions to be provided to the job candidate during the prescreening process, and to transmit audio and video information during an interview or during the prescreening process.

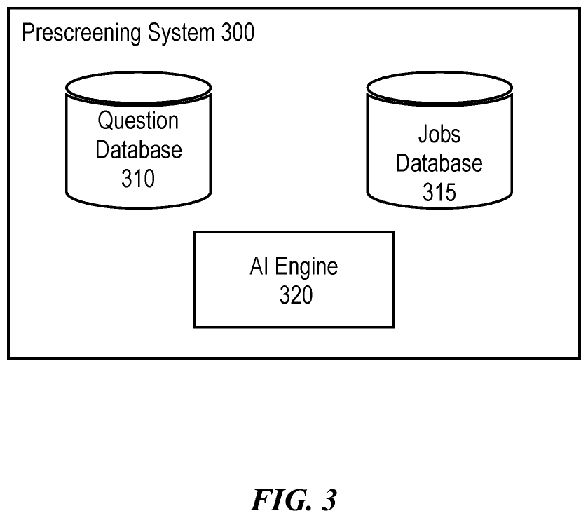

FIG. 3 illustrates a block diagram of the prescreening system 300 including a question database 310 in operable communication with an artificial intelligence engine 320. The question database 310 associates one or more stored questions with a job opportunity stored in a jobs database 315 such that suitable questions preselected by the organization are provided to the job candidate. For example, the organization may select the prescreening question, “Did you graduate high school?” to be asked during the prescreening process. The artificial intelligence engine 320 may determine suitable questions to ask the job candidate as well as determine suitable answers for each question. The artificial intelligence engine 320 may assign a score for each question, wherein the score is comprised of a point total for each answer.

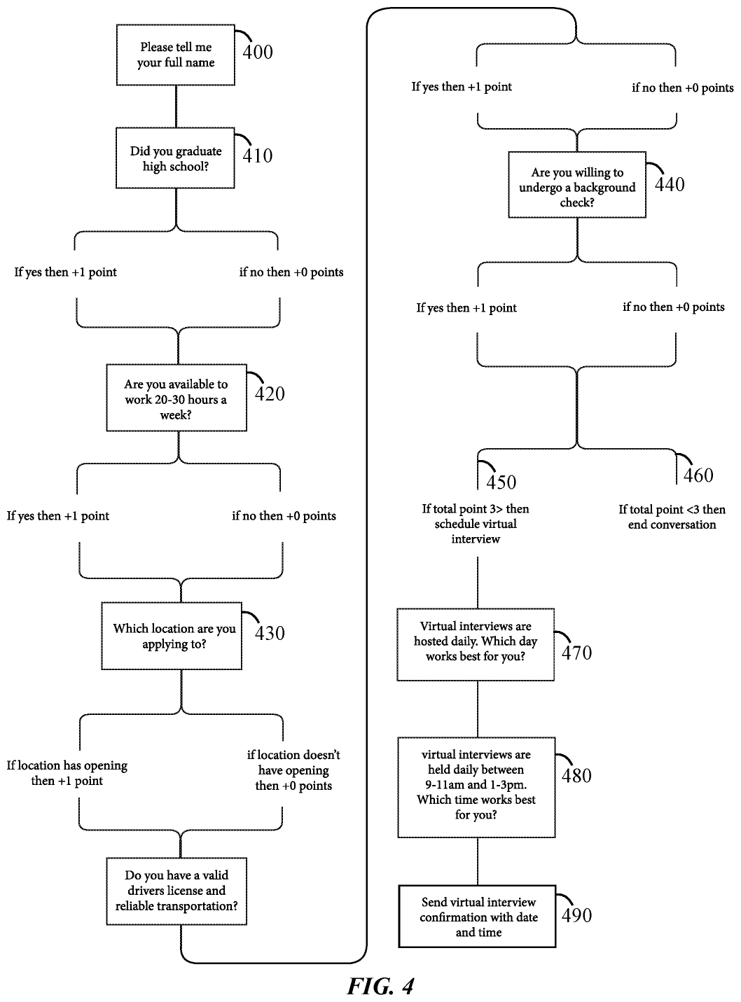

FIG. 4 illustrates a flowchart illustrating the prescreening process implemented by an artificial intelligence engine in an exemplary embodiment. While specific questions are provided, one skilled in the arts will readily understand that the questions are for exemplary purposes only and may be changed by the organization based on the job opening for which the job candidate is applying. In step 400 the job candidate is prompted for their name and in step 410, the job candidate is asked a question, such as, “Did you graduate high school?” If the job candidate responds with “yes,” they are given +1 point, and if the job candidate answers “no,” they are given +0 points. In step 420, the job candidate is asked a second questions, such as, “Are you available to work 20-30 hours a week?” If the job candidate responds with “yes,” they are given +1 point, and if the job candidate answers “no,” they are given +0 points. In step 430, the job candidate is asked a third question, such as, “Which location are you applying to?” If the job candidate responds with a location which has a current job opening, they are given +1 point, and if the job candidate responds with a location that does not have a current job opening, they are given +0 points. In step 440, the job candidate is asked a fourth question, such as, “Do you have a valid driver's license and reliable transportation?” If the job candidate responds with “yes,” they are given +1 point, and if the job candidate answers “no,” they are given +0 points. In step 450, the job candidate is asked a fifth question, such as, “Are you willing to undergo a background check?” If the job candidate responds with “yes,” they are given +1 point, and if the job candidate answers “no,” they are given +0 points. The points are added to a point total which is associated with the job candidate once all questions are completed and answered. In one example, a threshold value must be reached as illustrated in FIG. 4. In step 455, if the point total is 3 or greater, the interview may be scheduled between the job candidate and the organization. In step 460, if the point total is less than 3, the prescreening process is ended, and the interview may be unable to be scheduled. In steps 470 and 480, the job candidate is prompted to input a day and/or time to have an interview. In step 490, the system sends a virtual interview confirmation with the date and time of the interview.

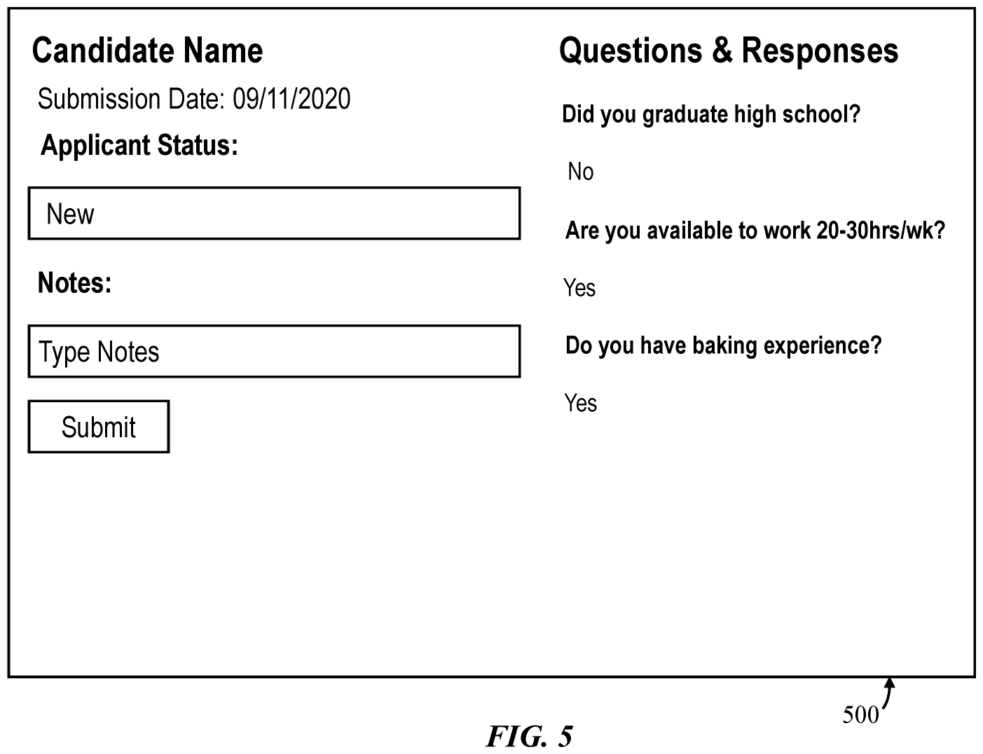

FIG. 5 illustrates a screenshot of an applicant interface 500 on the organization device wherein a member in the organization can view responses to the questions submitted by the job candidate. The applicant interface 500 may allow the organization to view the job candidates (i.e., the applicant's) information, job candidate status (e.g., new, expired, in progress), notes submitted by the job candidate and/or the organization, questions and responses, and the like. The applicant interface 500 may be utilized by the business to confirm or review answers submitted in response to the questions. For example, the artificial intelligence engine may have determined that the job candidate provided answers which resulted in a point total high enough to schedule an interview with the organization. The member of the organization may then utilize the applicant interface 500 to review the job candidate's answers before the interview is conducted.

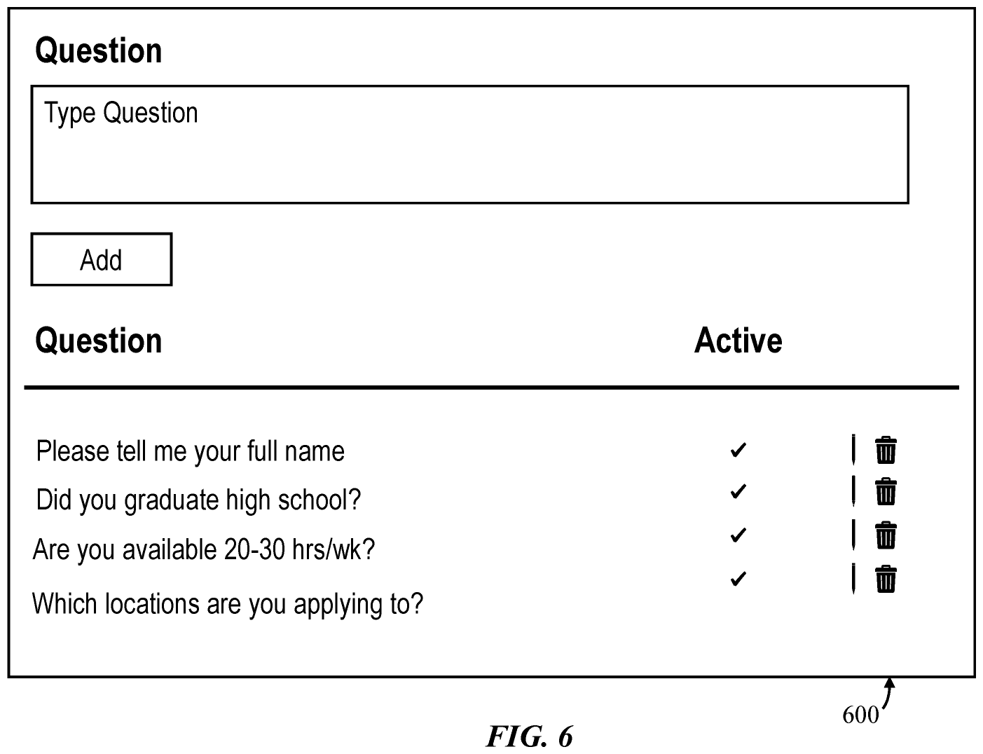

FIG. 6 illustrates a screenshot of the question interface 600 wherein the organization and members thereof may input questions to be transmitted to the job candidate during the prescreening process. A member of the organization may input various questions and indicate which questions are “active” for a particular job opening. For example, a job opening for an associate level position may prompt the job candidate with different questions when compared to a manager level position. The member of the organization may select from a list of question to indicate which questions should be active for the particular job opening. The question interface 600 may allow the member of the organization to create new questions, edit questions, remove questions, input a point value associated with each question (e.g., assign a higher point value to specific questions), etc.

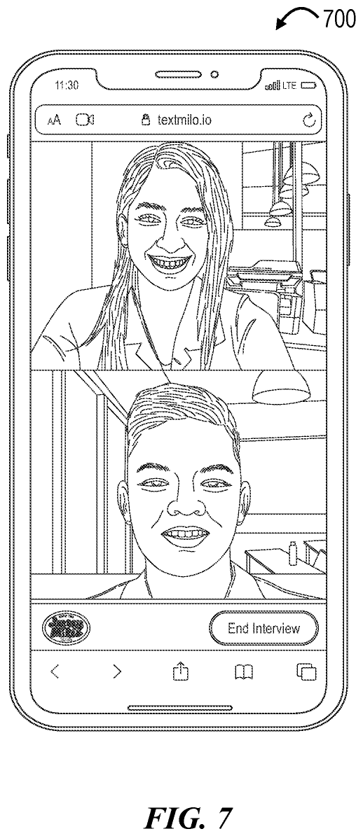

FIG. 7 illustrates a screenshot of the interview interface 700 wherein the job candidate 702 and organization member 704 may conduct an interview over a network as described hereinabove. The interview may be a one-on-one interview or may be a group interview as determined by the organization. It is a goal of the system to provide an interview platform without the requirement to download a third-party application over which the interview is conducted. The interview interface 700 may be in operable communication with the cameras of the job candidate device and organization device such that the interview is a virtual video interview between both parties. Alternatively, the interview interface 700 may utilize avatars or other visual elements instead of using a real-time video feed of each party.

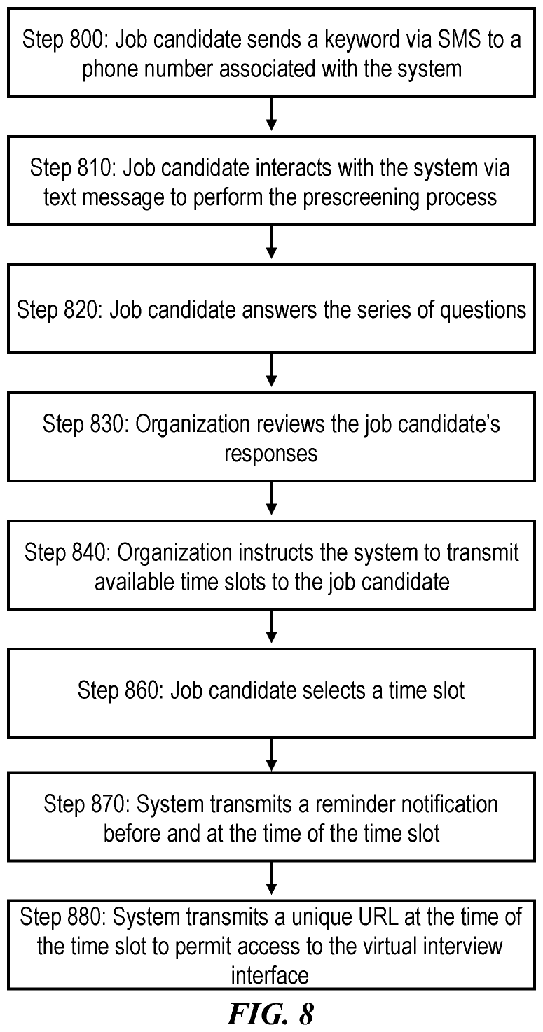

FIG. 8 illustrates a flowchart of the user flow while performing a prescreening process, scheduling an interview, and conducting an interview. In step 800, the job candidate sends a keyword via SMS to a phone number associated with the system or scans a quick response (QR) code. In step 810, the applicant interacts with the system via text message to perform the prescreening process. In such, the artificial intelligence engine transmits text messages to the job candidate and receives text message responses from the job candidate's device. In step 820, the job candidate answers the series of questions asked by the system. Answers are submitted by the text messaging system of the job candidate's device. In step 830, a member of the organization (e.g., a hiring manager) reviews the answers submitted by the job candidate. In step 840, the member of the organization instructs the system to transmit time slots for a virtual interview if the job candidate has successfully answered the questions submitted by the system. In step 860, the job candidate selects a time slot and confirms to proceed with the scheduling of the virtual interview. In step 870, the system transmits a reminder notification before and/or at the scheduled time slot of the virtual interview. In step 880, the system transmits a unique URL or similar link or code at the time of the interview. The URL will allow the job candidate to access the interview interface and engage with the member of the organization via a virtual interview.

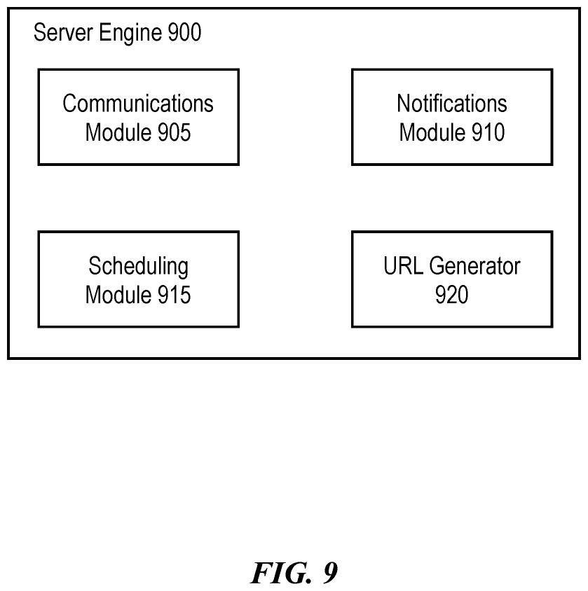

FIG. 9 illustrates a block diagram of the server engine 900 and modules including a communications module 905, notifications module 910, a scheduling module 915, and a URL generator 920. The communications module 905 permits the transmission of communications via a SMS messaging or similar communications between the job candidate device and the organization device. The notifications module 910 transmits notifications to the job candidate for various purposes, including to remind them of a scheduled interview, to send updates of job openings, and to send updates of their job applications and prescreening status. For example, the notifications module 910 may transmit a notification when their prescreening questions have been received by the organization and are under review. The scheduling module 915 is in operable communication with a calendar system to provide a means for scheduling a virtual interview between the job candidate and the organization. The URL generator 920 is operable to generate a unique URL or similar link which is transmitted to the job candidate at the time of the virtual interview. The unique URL may be utilized by both the job candidate and the organization to link each user to the interview interface.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A virtual interview system, the system comprising:
at least one job candidate device and at least one organization device in operable communication with a network;
an application system in operable communication with the network, the application system configured to transmit a plurality of questions to a user interface of the job candidate device; and
an artificial intelligence engine to analyze each response to the plurality of questions and assign a point value based on the response, wherein each point value for each of the plurality of questions is totaled to determine if a threshold value is reached, wherein the threshold value determines if the job candidate is permitted to schedule a virtual interview.

2. The system of claim 1, wherein the user interface is in operable communication with a job candidate database and an organization database.

3. The system of claim 2, wherein the job candidate database stores job candidate information, wherein the job candidate information is transmitted to the organization device.

4. The system of claim 3, wherein the organization database stores organization information comprising job openings and the plurality of questions.

5. The system of claim 1, further comprising a communications module to transmit text messages from the organization to the job candidate.

6. The system of claim 1, further comprising a notifications module to transmit notification to the job candidate.

7. The system of claim 1, further comprising a scheduling module to schedule the virtual interview if the job candidate meets the threshold value.

8. The system of claim 7, wherein the job candidate selects a date and a time to schedule the virtual interview.

9. The system of claim 8, further comprising a URL generator to generate a unique URL and transmit the unique URL to the job candidate at a time of the virtual interview.

10. A virtual interview system, the system comprising:
at least one job candidate device and at least one organization device in operable communication with a network;
an application system in operable communication with the network, the application system configured to transmit a plurality of questions to a user interface of the job candidate device;
an artificial intelligence engine to analyze each response to the plurality of questions and assign a point value based on the response, wherein each point value for each of the plurality of questions is totaled to determine if a threshold value is reached, wherein the threshold value determines if the job candidate is permitted to schedule a virtual interview; and
a notifications module to transmit notifications to the job candidate device to update the job candidate of the status of the virtual interview.

11. The system of claim 10, further comprising an interview interface to provide a real-time video and audio feed during the virtual interview.

12. The system of claim 11, further comprising an applicant interface to display answers to the plurality of questions.

13. The system of claim 12, further comprising a question interface to permit a member of the organization to select one or more of the plurality of questions stored in the questions database to be transmitted to the job candidate device.

14. The system of claim 13, wherein the user interface is in operable communication with a job candidate database and an organization database.

15. The system of claim 14, wherein the job candidate database stores job candidate information, wherein the job candidate information is transmitted to the organization device.

16. The system of claim 10, further comprising a communications module to transmit text messages from the organization to the job candidate.

17. The system of claim 10, further comprising a scheduling module to schedule the virtual interview if the job candidate meets the threshold value.

18. The system of claim 17, wherein the job candidate selects a date and a time to schedule the virtual interview.

19. The system of claim 18, further comprising a URL generator to generate a unique URL and transmit the unique URL to the job candidate at a time of the virtual interview.

20. A method for scheduling conducting a virtual interview, the method comprising the steps of:
transmitting a keyword via an SMS message;
interacting, via a job candidate device, with a plurality of questions;
answering, via the job candidate device, the plurality of questions;
reviewing, via an organization device, the answers to the plurality of questions;
selecting one or more time slots corresponding to availabilities for conducting a virtual interview;
selecting, via the job candidate device, the time slot;
transmitting, via a notifications module, a notification to remind a job candidate of the virtual interview time slot; and
generating, via a URL generator, a unique URL and transmitting the unique URL to the job candidate at the time slot of the scheduled virtual interview.
